(19) United States
(12) Patent Application Publication
(10) Pub. No.: US 2008/0063301 A1
(43) Pub. Date: Mar. 13, 2008

(54) Joint Segmentation and Registration

(76) Inventors: Luca Bogoni, Philadelphia, PA (US); Matthias Wolf, Philadelphia, PA (US); Gerardo Hermosillo Valadez, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/853,210

(22) Filed: Sep. 11, 2007

Related U.S. Application Data
(60) Provisional application No. 60/843,843, filed on Sep. 12, 2006.

(51) Int. Cl. G06K 9/32

(52) U.S. Cl. 382/294

(57) ABSTRACT

A method for joint segmentation and registration includes providing a plurality of datasets comprising images of an object of interest, and performing, iteratively, a segmentation and a registration of at least a portion of the plurality of datasets comprising, performing the segmentation of the plurality of datasets, outputting a segmentation result, performing the registration on the segmentation result, outputting a registration result, and merging information of the plurality of datasets, including the registration result, by propagating the segmentation result from each dataset to all other datasets.

### CROSS-REFERENCE TO RELATED APPLICATION

This application claims priority to U.S. Provisional Application Ser. No. 60/843,843, filed on Sep. 12, 2006, which is herein incorporated by reference in their entirety.

### BACKGROUND OF THE INVENTION

1. Technical Field

The present invention relates to image processing, and more particularly to a system and method for joint segmentation and registration.

2. Discussion of Related Art

The problems of segmentation and registration are typically approached individually.

Depending on the imaging modality, image quality, noise level, and the shape and size of the structure to be segmented, segmentation can be a challenging task in which quality and robustness can be increased by using additional information. One source of additional information might be derived from the knowledge that the images include the same structures acquired at different times. Furthermore, if a manual segmentation of the particular structure is available in a given image (volume), or if the automated segmentation is simplified because of better image quality, or if the data has been acquired using a different imaging technique, or a special scanning protocol are employed, this knowledge can be transferred and incorporated into the new (volumetric) image by registering these datasets. This can be accomplished by aligning them in such a way that the location of the target structure in one dataset corresponds to the location of the same structure in the second dataset. This information can then be used to guide the segmentation process by, for example, restricting the search space and estimating image specific properties based on the information obtained from the first dataset.

Segmentation of a particular structure in two different images may also be used to guide registration. Namely, if a structure, e.g., liver, spinal cord, diaphragm, or kidneys, can be segmented in two images (volumes) acquired at two time points, the correspondence of structures can be used as a means to regularize the registration. The ability to identify corresponding structures can be used to decouple various motions, such as diaphragm motion and patient pose.

When registering the two different images there may be multiple causes which make the registration process difficult or may lead to inaccurate results. This could be due to partial occlusions, namely a structure or a portion may not be present in one image. Even if the target structure is fully present in both datasets, it may happen that the surrounding areas are very different, e.g., because of motion, noise, intensity, image acquisition, imaging modality, etc. Differences in structures between acquisitions at two different time points may also depend on the type of tissue, e.g., muscular vs. bone, as well as organ, e.g., kidneys vs. bladder or colon, as well as pathological changes that may have taken place between the two time points, for example, in the case of therapy.

One way to overcome some of these problems is to use additional information in the registration process. If the registration can be restricted to a known region, registration cannot be misled by changes in the surrounding area or by missing data. In this case it is possible to optimize the registration in such a way that highest accuracy will be achieved in those target regions. Additional information may also be obtained by considering multiple (volumetric) images acquired over different time points.

Therefore, a need exists for a system and method for joint segmentation and registration.

### SUMMARY OF THE INVENTION

According to an embodiment of the present disclosure, a method for joint segmentation and registration includes providing a plurality of datasets comprising images of an object of interest, and performing, iteratively, a segmentation and a registration of at least a portion of the plurality of datasets comprising, performing the segmentation of the plurality of datasets, outputting a segmentation result, performing the registration on the segmentation result, outputting a registration result, and merging information of the plurality of datasets, including the registration result, by propagating the segmentation result from each dataset to all other datasets.

According to an embodiment of the present disclosure, a method for joint segmentation and registration includes providing a plurality of datasets comprising images of an object of interest, and performing, iteratively, a segmentation and a registration of at least a portion of the plurality of datasets comprising, performing the registration on the plurality of datasets, outputting a registration result, performing the segmentation of the plurality of datasets, outputting a segmentation result, and merging information of the plurality of datasets, including the registration result, by propagating the segmentation result from each dataset to all other datasets.

According to an embodiment of the present disclosure, a system for joint segmentation and registration includes a memory device storing a plurality of datasets comprising images of an object of interest and a plurality of instructions embodying the system for joint segmentation and registration and a processor for receiving the plurality of datasets and executing the plurality of instructions to perform a method including performing, iteratively, a segmentation and a registration of at least a portion of the plurality of datasets comprising, performing the segmentation of the plurality of datasets, outputting a segmentation result, performing the registration on the segmentation result, outputting a registration result, and merging information of the plurality of datasets, including the registration result, by propagating the segmentation result from each dataset to all other datasets.

A system for joint segmentation and registration includes a memory device storing a plurality of datasets comprising images of an object of interest and a plurality of instructions embodying the system for joint segmentation and registration, and a processor for receiving the plurality of datasets and executing the plurality of instructions to perform a method comprising, performing, iteratively, a segmentation and a registration of at least a portion of the plurality of datasets comprising, performing the registration on the plurality of datasets, outputting a registration result, performing the segmentation of the plurality of datasets, outputting a segmentation result, and merging information of the plurality of datasets, including the registration result, by propagating the segmentation result from each dataset to all other datasets.

### BRIEF DESCRIPTION OF THE DRAWINGS

Preferred embodiments of the present invention will be described below in more detail, with reference to the accompanying drawings:

FIG. 1 shows a method for joint segmentation and registration according to an embodiment of the present disclosure;

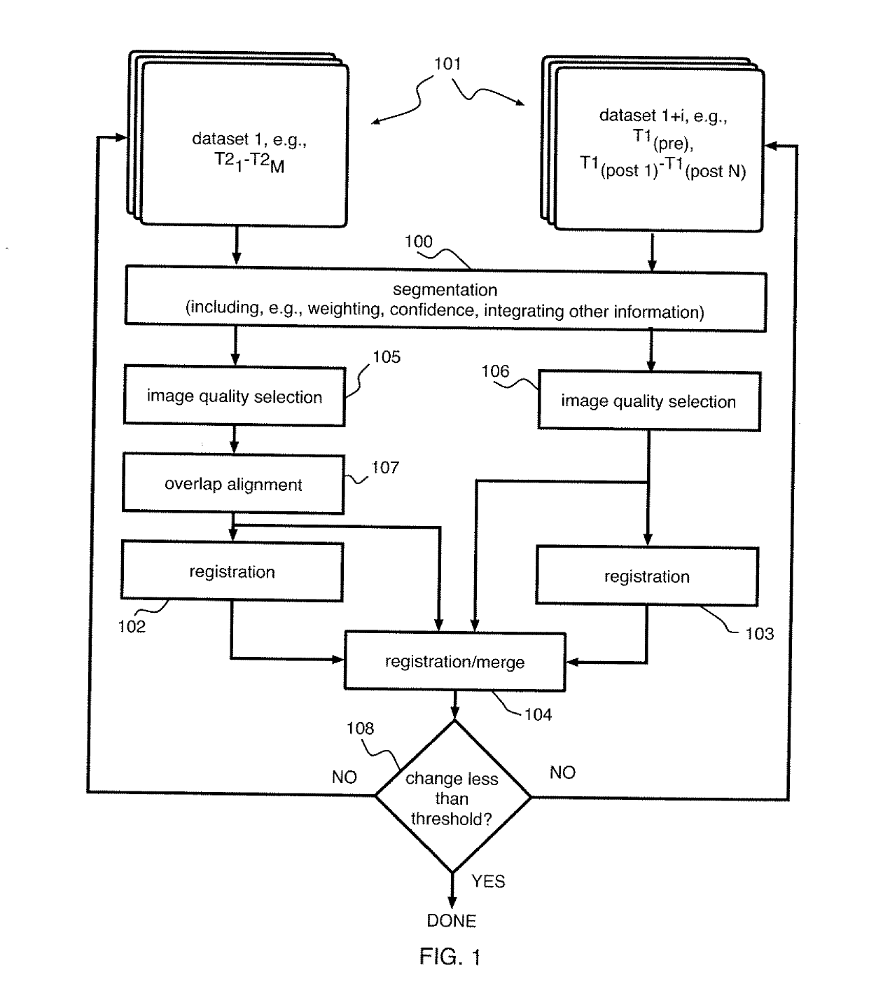

FIG. 2 shows a method for joint segmentation and registration according to an embodiment of the present disclosure; and

FIG. 3 is a diagram of a system according to an embodiment of the present disclosure.

### DETAILED DESCRIPTION OF EXEMPLARY EMBODIMENTS

In the description herein, exemplary magnetic resonance (MR) images (volumetric images) are used to described embodiments of the present disclosure. Embodiments of the present disclosure can be applied to multiple (volumetric) images. In an exemplary embodiment using MR images of a colon more than two volumes are described.

According to an exemplary embodiment of the present disclosure, for joint segmentation/registration of the colon in MR images input includes data sets acquired at different time points. For example, a typical examination of the colon includes of different data sets (typically 4 or 5 covering the whole colon or parts of it) acquired at different time points with different acquisition parameters, e.g., T1 and T2 weighted images.

Each of those scans has its own properties. For example, in T2 MR scans the lumen appears bright whereas it appears dark in T1 scans. Further, the application of contrast agents can change the appearance of soft tissue over time and in different acquisitions.

T2 scans allow for a good segmentation of the colon but may have artifacts and are acquired with thick slices that limit the detection of small polyps, Whereas T1 scans are typically noisier but are acquired with a thinner slice thickness. T1 scans also tend to have local inhomogeneities and blurred edges which makes the segmentation of the colon more difficult.

According to an embodiment of the present disclosure, a segmentation 100 is performed on datasets 101. Given a segmentation, the datasets 101 (or portions of the datasets 101) with a sufficient quality are automatically selected 105-106 for use in a registration. In a first iteration the segmentation 100 may give only incomplete results. The selected datasets are automatically registered 102-103 using results of the (partially) segmented object of interest, e.g., a colon. Information of all datasets is merged by propagating the segmentation result from each dataset to all other datasets 104. Alternatively, the registration may be performed on all the datasets together 104, skipping the registration of blocks 102-103. The iterations are repeated from block 101 until changes in segmentation or registration are below a given threshold 108 (the threshold may be ignored for a first result, such that at least two iterations are performed). For certain data sets additional steps may be used, for example, for T2 images where a field of view may change between images, an alignment of overlapping portions may be determined 107.

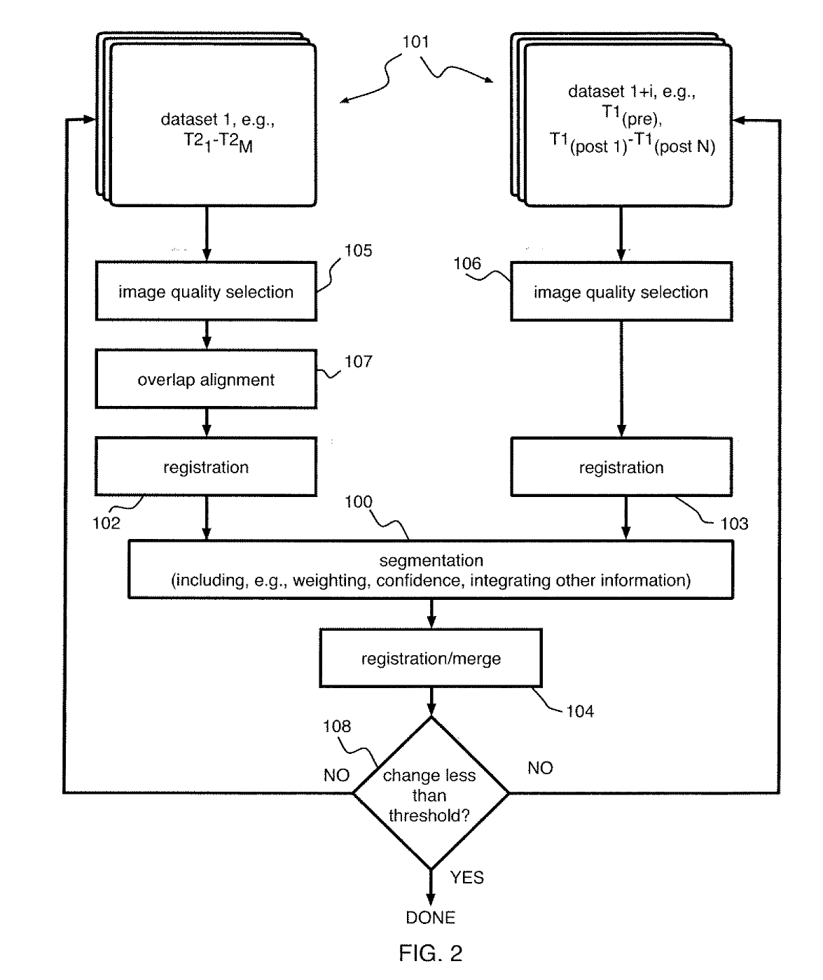

Referring to FIG. 2, the registration, e.g., 102-104, may be performed before segmentation 100A-100B.

The automatically selection of a portion of the datasets 105-106 for use in the registration may be based on, for example, brightness, contrast, noise, etc.

This iterative refinement between registration and segmentation, automatically segments structures presenting uniform and cohesive characteristics in an image, e.g., bright lumen in the colon in one image, dark lumen in later volumes acquired in the temporal sequence. Registration allows a coherent matching of structures.

These structure segmentations can also be weighted with respect to the probability that a given voxel belongs to the particular segmented region. For instance, bright lumen might yield strong confidence of the segmentation 100 and of the boundaries, while in certain portions of the dark lumen this may lead to areas of lower confidence.

The segmentation 100 for output for a given organ then may be obtained by integrating the information that maximizes the probability that a particular voxel belongs to a segmented region and that minimized the local residual error after registration.

Additionally, the confidence of the segmentation 100 may be used as guidance to registration, allowing the incremental evolution from regions of higher confidence.

For example, if the lower portion of the abdomen, e.g., rectum, sigmoid and cecum, have strong segmentation, the registration may provide an initial alignment and a refinement in these regions. Then segmentation can further spread upward, using the evidence from multiple images, gaining further confidence in an upper portion of the colon, e.g., descending and ascending. The registration process can then be refined, the segmentation process can then be repeated and so on.

Thus, the interaction between segmentation and registration can take place at a global or at a local level. At the local region/structure level, can be understood and a spreading confidence from particular structures which can work as landmarks.

A joint segmentation and registration process may be refined further by additional considerations including additional known structures segmented in both images, e.g., kidneys or skeletal structures, used to provide constraints to the registration.

The registration process can also be guided adaptively by searching for structures with stronger demarcation in areas of poor segmentation of the organ, for example, by looking for skeletal structure or lymph nodes, or other organs. These may allow for further constraints to the registration and determination of proper boundaries for the organ, e.g., colon, in the areas of poor contrast.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

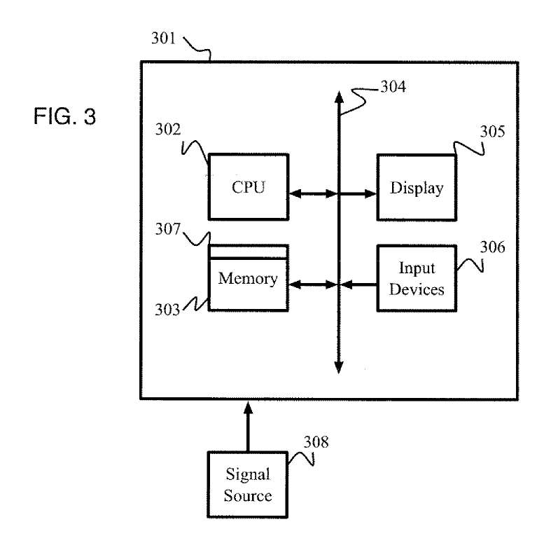

Referring to FIG. 3, according to an embodiment of the present invention, a computer system 301 for joint segmentation and registration comprise, inter alia, a central processing unit (CPU) 302, a memory 303 and an input/output (I/O) interface 304. The computer system 301 is generally coupled through the I/O interface 304 to a display 205 and various input devices 206 such as a mouse and keyboard. The support circuits can include circuits such as cache, power supplies, clock circuits, and a communications bus. The memory 303 can include random access memory (RAM), read only memory (ROM), disk drive, tape drive, etc., or a combination thereof. The present invention can be implemented as a routine 307 that is stored in memory 303 and executed by the CPU 302 to process a signal, e.g., a closed surface mesh, from the signal source 308. As such, the computer system 301 is a general purpose computer system that becomes a specific purpose computer system when executing the routine 307 of the present invention.

The computer platform 301 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a system and method for joint segmentation and registration, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer readable medium embodying instructions executable by a processor to perform a method for joint segmentation and registration comprising:
providing a plurality of datasets comprising images of an object of interest; and
performing, iteratively, a segmentation and a registration of at least a portion of the plurality of datasets comprising,
performing the segmentation of the plurality of datasets,
outputting a segmentation result,
performing the registration on the segmentation result,
outputting a registration result, and
merging information of the plurality of datasets, including the registration result, by propagating the segmentation result from each dataset to all other datasets.

2. The computer readable medium of claim 1, wherein the method further comprises determining whether a change from previously merged information is greater than a predetermined threshold,
if the change is not less than the threshold iterating the method, and
if the change is less than the threshold otherwise outputting a jointly segmented and registered dataset.

3. The computer readable medium of claim 1, wherein the method further comprises selecting a portion of the plurality of datasets for the registration based on image quality.

4. The computer readable medium of claim 1, wherein the method further comprises aligning at least a portion of the plurality of datasets prior to the registration.

5. The computer readable medium of claim 1, wherein the method further comprises weighting the segmentation result with respect to a probability that a given voxel belongs to a segmented region.

6. The computer readable medium of claim 1, wherein the segmentation result maximizes a probability that a particular voxel belongs to a segmented region and minimizes a local residual error after the registration.

7. The computer readable medium of claim 1, wherein the method further comprises determining a confidence of the segmentation result, and using the confidence in the registration.

8. A computer readable medium embodying instructions executable by a processor to perform a method for joint segmentation and registration comprising:
providing a plurality of datasets comprising images of an object of interest; and
performing, iteratively, a segmentation and a registration of at least a portion of the plurality of datasets comprising,
performing the registration on the plurality of datasets,
outputting a registration result,
performing the segmentation of the plurality of datasets,
outputting a segmentation result, and
merging information of the plurality of datasets, including the registration result, by propagating the segmentation result from each dataset to all other datasets.

9. The computer readable medium of claim 8, wherein the method further comprises determining whether a change from previously merged information is greater than a predetermined threshold,
if the change is not less than the threshold iterating the method, and
if the change is less than the threshold otherwise outputting a jointly segmented and registered dataset.

10. The computer readable medium of claim 8, wherein the method further comprises selecting a portion of the plurality of datasets for the registration based on image quality.

11. The computer readable medium of claim 8, wherein the method further comprises aligning at least a portion of the plurality of datasets prior to the registration.

12. The computer readable medium of claim 8, wherein the method further comprises weighting the segmentation result with respect to a probability that a given voxel belongs to a segmented region.

13. The computer readable medium of claim 8, wherein the segmentation result maximizes a probability that a particular voxel belongs to a segmented region and minimizes a local residual error after the registration.

14. The computer readable medium of claim 8, wherein the method further comprises determining a confidence of the segmentation result, and using the confidence in the registration.

15. A system for joint segmentation and registration comprising:
a memory device storing a plurality of datasets comprising images of an object of interest and a plurality of instructions embodying the system for joint segmentation and registration; and
a processor for receiving the plurality of datasets and executing the plurality of instructions to perform a method comprising,
performing, iteratively, a segmentation and a registration of at least a portion of the plurality of datasets comprising,
performing the segmentation of the plurality of datasets,
outputting a segmentation result,
performing the registration on the segmentation result,
outputting a registration result, and
merging information of the plurality of datasets, including the registration result, by propagating the segmentation result from each dataset to all other datasets.

16. The system of claim 15, wherein the method further comprises determining whether a change from previously merged information is greater than a predetermined threshold,
if the change is not less than the threshold iterating the method, and
if the change is less than the threshold otherwise outputting a jointly segmented and registered dataset.

17. A system for joint segmentation and registration comprising:
a memory device storing a plurality of datasets comprising images of an object of interest and a plurality of instructions embodying the system for joint segmentation and registration; and
a processor for receiving the plurality of datasets and executing the plurality of instructions to perform a method comprising,
performing, iteratively, a segmentation and a registration of at least a portion of the plurality of datasets comprising,
performing the registration on the plurality of datasets,
outputting a registration result,
performing the segmentation of the plurality of datasets,
outputting a segmentation result, and
merging information of the plurality of datasets, including the registration result, by propagating the segmentation result from each dataset to all other datasets.

18. The system of claim 17, wherein the method further comprises determining whether a change from previously merged information is greater than a predetermined threshold,
if the change is not less than the threshold iterating the method, and
if the change is less than the threshold otherwise outputting a jointly segmented and registered dataset.
